(19) United States
(12) Patent Application Publication
(10) Pub. No.: US 2025/0178570 A1
(43) Pub. Date: Jun. 5, 2025

(54) DEVICE FOR WIPING AN OPTICAL SURFACE OF AT LEAST ONE OPTICAL ELEMENT OF A VEHICLE

(71) Applicant: VALEO SYSTEMES D'ESSUYAGE, La Verriere (FR)

(72) Inventors: Gerald CAILLOT, La Verriere (FR); Vincent IZABEL, La Verrière (FR); Jean Michel JARASSON, La Verrière (FR)

(73) Assignee: VALEO SYSTEMES D'ESSUYAGE, La Verriere (FR)

(21) Appl. No.: 18/837,221

(22) PCT Filed: Feb. 16, 2023
(86) PCT No.: PCT/EP2023/053943

§ 371 Date: Aug. 9, 2024

(30) Foreign Application Priority Data
Feb. 16, 2022 (FR) FR2201366

(51) Int. Cl. B60S 1/56; B60S 1/08; B60S 1/52

(52) U.S. Cl. CPC B60S 1/566; B60S 1/524; B60S 1/08

(57) ABSTRACT

The invention provides a device for wiping an optical surface of at least one optical element of a vehicle, including a wiping unit having a wiping part for wiping the optical surface and a support element for supporting the wiping part, moving the wiping part so that it wipes the optical surface by making contact with the optical surface, a drive member for driving the wiping unit, the wiping unit being in one piece. The invention gives the device a simple structure.

### TECHNICAL FIELD

The invention relates to a device for wiping an optical surface of at least one optical element of a vehicle.

### BACKGROUND OF THE INVENTION

Motor vehicles are increasingly fitted with optical elements, such as optical position sensors. The function of the optical position sensors is to gather information about the area surrounding the vehicle, in particular notably to assist the driver in driving and/or maneuvering this vehicle. To this end, an optical sensor is commonly installed on the vehicle so as to collect information about the area surrounding the vehicle, such as the area to the front and/or rear of the vehicle. The detection system is therefore, for example, installed at the front and/or at the rear.

However, such locations are particularly exposed to dirt such as dirty water, dust or other types of spray. This dirt hinders the transmission and reception of information and can disrupt the operation of the optical sensor, or even stop it from operating.

The use of devices for wiping an optical surface of optical elements so as to remove this dirt from them has been proposed, but they have a complex structure.

There is a need for a device for wiping an optical surface of an optical element of a vehicle which has a simple and compact structure.

### SUMMARY OF THE INVENTION

The aim of the invention is to provide a device for wiping an optical surface of an optical element of a vehicle which has a simple form. The aim of the invention is also to provide a compact wiping device which has low bulk.

For this, the invention provides a device for wiping an optical surface of at least one optical element of a vehicle, comprising a wiping unit having a wiping part for wiping the optical surface and a support element for supporting the wiping part, moving the wiping part so as to wipe the optical surface by making contact with the optical surface, the device also comprising a drive member for driving the wiping unit, the wiping unit being in one piece.

In a variant, a material forming the wiping part is different from a material forming the support element.

In a variant, the support element comprises at least one portion which is stiffer than at least one portion of the wiping part.

In a variant, the wiping unit extends in a longitudinal direction and is capable of exerting a constant pressure on the optical surface along the longitudinal direction.

In a variant, the wiping part and/or the support element comprise/comprises at least one first portion which is stiffer than at least one second portion in the longitudinal direction.

In a variant, the wiping part and/or the support element at least partially comprise/comprises a lattice structure.

For example, the support element comprises at least the portion formed by a first lattice structure configuration and/or by a first material, which configuration and/or material is configured to give the portion a first stiffness.

For example, the wiping part comprises at least the portion formed by a second lattice structure configuration and/or by a second material, which configuration and/or material is configured to give the portion a second stiffness.

In a variant, the first stiffness is greater than the second stiffness.

In a variant, the wiping part and/or the support element comprise/comprises different materials defined on the basis of the stiffness to be given to the portions.

In a variant, the wiping part and/or the support element have/has a profile transverse to their length, of which the shape is variable along the length and which is defined on the basis of the pressure of the wiping part on the optical surface.

In a variant, the wiping unit has a wiping movement which goes back and forth between end positions while the optical surface is being wiped, the dimension of the wiping unit in a direction orthogonal to the optical surface being different between the end positions in relation to the dimension at the end positions, the wiping part and/or the support element being capable of absorbing the variation in dimension.

In a variant, the wiping part and/or the support element are/is at least partially in the form of a lattice, the lattice having a structure which absorbs the variation in dimension.

In a variant, the wiping part and/or the support element have/has a profile transverse to their length which absorbs the variation in dimension.

In a variant, the device comprises a duct for cleaning liquid in the wiping unit.

In a variant, the duct for cleaning liquid is a channel for liquid fitted or formed in the lattice-like wiping part.

In a variant, the wiping part comprises a portion made of more flexible material for wiping the optical surface.

In a variant, the material of the more flexible portion is made of silicone or thermoplastic polyurethane.

In a variant, the device also comprises resistive heating tracks in the wiping part.

In a variant, the wiping unit is obtained as a single piece by a manufacturing process.

In a variant, wherein the wiping unit is obtained by an additive manufacturing process.

The different embodiments can be taken in combination or considered in isolation.

### BRIEF DESCRIPTION OF DRAWINGS

Further features and advantages of the present invention will become apparent from reading the following detailed description, for the understanding of which reference will be made to the appended figures, in which:

FIG. 1 shows a view of one exemplary embodiment of a wiping device;

FIG. 2 shows a view of another exemplary embodiment of a wiping device;

FIG. 3 shows a sectional view through one example of the device according to FIG. 1 or 2;

FIG. 4 shows a sectional view through another example of the device according to FIG. 1 or 2;

FIG. 5 shows a sectional view through another example of the device according to FIG. 1 or 2;

FIG. 6 shows one example of a lattice structure;

FIG. 7 shows another example of a lattice structure;

FIG. 8 shows another example of a lattice structure; and

FIG. 9 shows another example of a lattice structure.

The drawings in the figures are not to scale. Similar elements are generally denoted by similar references in the figures. In the context of this document, identical or analogous elements may bear the same references. Furthermore, the presence of reference numbers or letters in the drawings cannot be considered limiting, including when these numbers or letters are indicated in the claims.

### DETAILED DESCRIPTION OF THE INVENTION

The invention provides a device for wiping an optical surface of at least one optical element of a vehicle. The device comprises a wiping unit having a wiping part for wiping the optical surface and a support element for supporting the wiping part. The support element moves the wiping part so that it wipes the optical surface by making contact with the optical surface. The device also comprises a drive member for driving the wiping unit. In this device, the wiping unit is in one piece. This gives the device a simple structure. This is because the one-piece nature of the wiping unit, comprising the wiping part, and the support element saves the multiplication of separate parts to be assembled.

FIG. 1 is a view of one example of the wiping device 10. The device 10 makes it possible to wipe an optical surface 12 of at least one optical element of a vehicle, which is not shown. The optical element may be a driving assistance means. The optical element makes it possible to gather information about the position of and the area surrounding the motor vehicle, in particular notably to assist the driver in driving and/or maneuvering this vehicle. It may be an image capturing means for assisting the driver notably in performing parking and/or reversing maneuvers (a camera, for example); it may also be a signal transmitting and/or receiving means, likewise for assisting the driver in performing maneuvers but also in driving (such as a sensor, an optical sensor, for example a lidar, which stands for “light detection and ranging” or “laser imaging, detection, and ranging”). The optical element may also be a front or rear headlamp.

The optical element interacts with the surrounding area by means of the optical surface 12. It may be a protective surface between the optical element and the surrounding area. For example, it may be a surface of a pane fitted between the optical element and the surrounding area, or a surface of a casing which encloses a sensor (such as a face of a lidar casing). It may be a constituent part of the optical element, such as the surface of a focusing lens of a camera. It may be the surface of the protective pane of a headlamp. The surface may be opaque (to the visible wavelengths). The surface may be transparent to the emission and reception wavelengths of the optical element. It is also possible to envisage multiple optical elements interacting with the surrounding area by means of a single optical surface 12.

The device 10 comprises a wiping unit 14 which wipes the optical surface 12. More specifically, the unit 14 wipes the optical surface 12 by making contact with the surface. This makes it possible to effectively wipe both dust and thrown-up solid materials or splashings of liquid from the optical surface 12. The operation of the optical element is thus improved.

The wiping unit 14 has a wiping part 16. Within the wiping unit 14, the wiping part 16 performs the function of wiping the optical surface 12. In particular, the wiping part is in contact with the optical surface 12. The wiping unit 14 also has a support element 18 for supporting the wiping part 16. The support element 18 keeps the wiping part 16 in contact with the optical surface 12. The support element 18 also moves the wiping part 16 so that it wipes the optical surface by making contact with the optical surface. In other words, the support element 18 transmits the movement of a drive member 15 to the wiping part 16. In addition, the wiping unit may extend in a longitudinal direction. The wiping unit 14 may have an elongate shape. The wiping unit may have an longitudinal shape. The same applies to the wiping part 16 and the support element 18.

The wiping unit 14 is in one piece in the sense that it is made as a single part. The wiping part 16 and the support element 18 of the wiping unit 14 are in one piece. They are one and the same part. In other words, the wiping part 16 and the support element 18 of the wiping unit 14 are two parts which are coincident. The wiping unit 14 does not have (or is devoid of) fitted means for assembling the wiping part 16 and the support element 18 to each other. The wiping part 16 and the support element 18 cannot be separated from one another—without destroying their physical integrity. The advantage of having a one-piece assembly is that it is easy to manufacture the wiping unit 14. Dispensing with fitted assembly means for assembling the parts to each other makes the manufacture less expensive. In addition, the wiping unit 14 is compact and has reduced bulk. The wiping unit 14 is less bulky in a direction orthogonal to the optical surface 12. As a result, the wiping unit 14 may be 10 mm or less in a direction orthogonal to the optical surface 12. Reduced bulk of the wiping unit 14 is advantageous because it makes it possible to mount it more easily in areas surrounding the vehicle that have a restricted amount of available space. The same applies for the device 10.

The wiping unit 14 may be obtained by a process for adhesively bonding the wiping part 16 and the support element 18 in order to form a one-piece assembly therefrom—which is to say forming a single part, and they cannot be separated from one another without destroying their physical integrity. This may be a process for gluing the wiping part 16 and the support element 18, a process for welding the wiping part 16 and the support element 18, for example by ultrasonic welding, or a process for fusing material of the surfaces of the wiping part 16 and the support element 18 that are in contact with one another.

The wiping unit 14 may be obtained as a single piece. The wiping part 16 and the support element 18 are manufactured at the same time. There is no need to manufacture and assemble various parts or to use means for fixing the constituent parts to one another. The wiping unit 14 can therefore be manufactured more quickly and less expensively. Furthermore, from a visual perspective, there is no boundary between the one-piece wiping part 16 and support element 18.

By way of example, the wiping unit 14 may be for example obtained by an additive manufacturing (or three-dimensional (3D) printing) process. The wiping unit 14 is produced by a succession of layers of material deposited using a wire, or thermally fused by one or more lasers, or chemically fused with a binder. On a part produced by additive manufacturing, the surface finish is defined by an aftertreatment (mechanical polishing, chemical polishing, etc.) In addition, additive manufacturing makes it possible to obtain complex parts (such as hollow parts, internal channels, certain complex undercuts, etc.). Again by way of example, the wiping unit 14 may be obtained by an injection or co-injection molding process. For a part produced by molding, the surface finish is defined by the surface finish of the mold. As a result, the surface finish can be directly clean and smooth in certain desired areas (such as visible surfaces, functional surfaces for assembly with other parts, etc.) and rougher elsewhere (such as in non-visible areas, or areas without interfaces).

The device 10 also comprises the drive member 15 for driving the wiping unit 14. The drive member 15 makes it possible to drive the wiping unit 14 in the wiping movement and in particular to make it pass over the optical surface so as to wipe the latter, in this case by making contact with it. The wiping by the wiping unit 14 is performed on at least one portion of the optical surface 12 by means of which the optical element interacts with the surrounding area—preferably, all the optical surface 12. The drive member can drive the wiping unit 14 backwards and forwards in a back-and-forth wiping movement. The drive member can drive the wiping unit between a first end position and a second end position, the optical surface 12 being wiped between these two positions. In particular, the drive member 15 is conFig.d to drive the wiping unit 14 directly. In other words, the drive member 15 is directly connected to the wiping unit 14. The drive member 15 may comprise a motor 17, preferably an electric motor.

The wiping unit 14 constitutes a one-piece assembly with a section forming an arm and a section forming a wiper, the wiper comprising a section forming a blade rubber in contact with the optical surface to be cleaned and at least one section forming a vertebra which supports the blade rubber (any connector and articulation between these parts is thus dispensed with); the drive member 15 drives this assembly directly.

According to FIG. 1, the drive member 15 drives the wiping unit 14 in a circular (or rotational) movement. The support element 18 then drives the wiping part 16 in a circular wiping movement. The advantage is that the device, comprising the drive member and the wiping unit, is compact and has low bulk. The drive member 15 may comprise an element for transmitting the wiping movement to the wiping unit 14. For example, the drive member 15 comprises a driveshaft 20 to which the wiping unit 14 is connected. The shaft 20 is driven in rotation by the motor 17 to give the wiping unit its circular movement. An interface 22 of the wiping unit 14 makes it possible to fix the wiping unit 14 to the shaft 20. The support element 18 thus connects the wiping part 16 to the shaft 20. It is also possible to envisage the shaft 20 being in one piece with the wiping unit 14. Irrespective of the configuration of the drive member 15, the drive member 15 drives the wiping unit 14 directly.

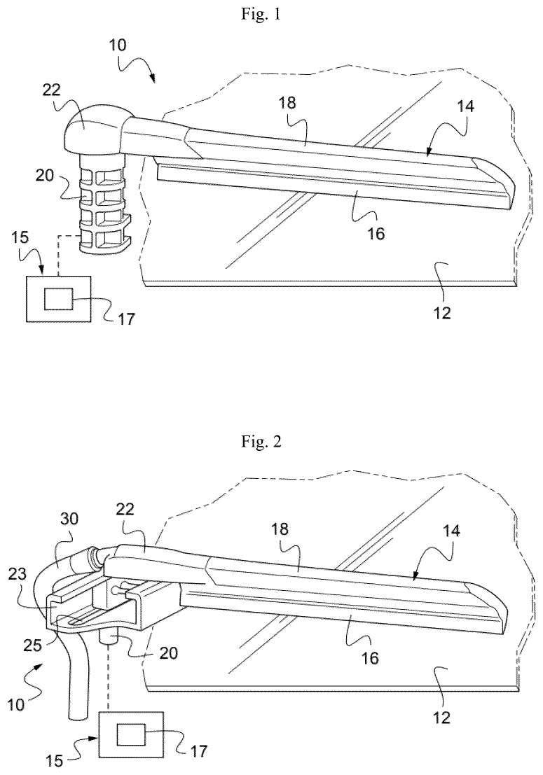

FIG. 2 is a view of another example of the wiping device 10. FIG. 2 differs from FIG. 1 in that the drive member 15 drives the wiping unit 14 in a linear (or translational) movement. The support element 18 then drives the wiping part 16 in a linear wiping movement. The advantage is that the wiping unit 14 can wipe all of the optical surface. The drive member 15 comprises an element for transmitting the wiping movement to the wiping unit. For example, the drive member 15 comprises the driveshaft 20 to which the wiping unit 14 is connected. The shaft 20 in FIG. 2 is driven by the motor 17, in translation on a rail 23 and via an aperture 25, to give the wiping unit its linear movement. The interface 22 of the wiping unit 14 makes it possible to fix the wiping unit 14 to the shaft 20. The support element 18 thus connects the wiping part 16 to the shaft 20. It is also possible to envisage the shaft 20 being in one piece with the wiping unit 14. Irrespective of the configuration of the drive member 15, the drive member 15 drives the wiping unit 14 directly.

The materials of the wiping part 16 and of the support element 18 may be the same—thereby making it easier to manufacture the wiping unit 14. With preference, a material forming the wiping part 16 is different from a material forming the support element 18. The wiping unit 14 may be a part comprising multiple materials. An advantage is that it is possible to provide various functions within the one-piece wiping unit 14. For example, the support element 18 may comprise at least one portion which is stiffer than at least one portion of the wiping part 16. This makes it possible to have a stiff portion of the wiping unit 14 for transmitting the movement to the wiping unit 14 and a flexible portion of the wiping unit 14 for wiping the optical surface 12.

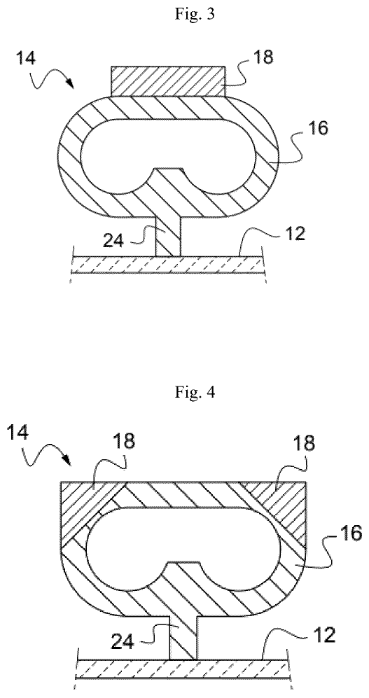

The wiping unit 14 may comprise one or more materials which are resistant to bending, fatigue resistant and/or heat resistant. The support elements 18 may comprise materials having one or more of these properties. By way of example, the wiping unit 14 may comprise PA11 (or polyamide 11, a thermoplastic polymer) or PA12 (or nylon 12, a nylon polymer) for forming the support element 18. The wiping element 14 (in particular the support element 18) may be filled with reinforcing fibers. The reinforcing fibers make it possible to increase the stiffness of a part while still limiting its mass (such as carbon or glass fibers). The wiping unit 14 may also comprise one or more materials which are elastically deformable while still being fatigue resistant and/or heat resistant. The wiping part 16 may comprise materials having one or more of these properties. For example, natural or synthetic rubber may be used to form all or some of the wiping part 16. The wiping unit 14 may also comprise one or more elastic, deformable and/or flexible materials for forming the wiping part 16 in contact with the optical surface 12, so as to improve the wiping (extension 24 in FIGS. 3 to 5). For example, silicone or thermoplastic polyurethane (or TPU) may be used to form all or some of the wiping part 16.

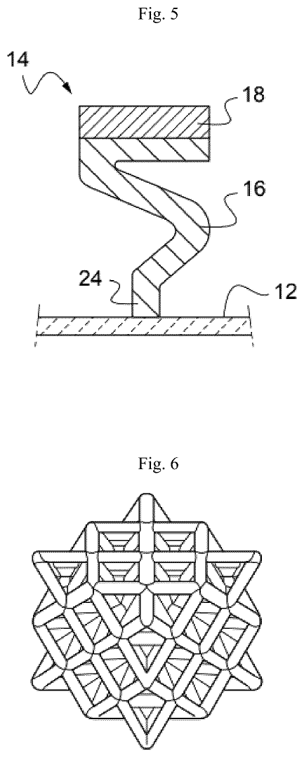

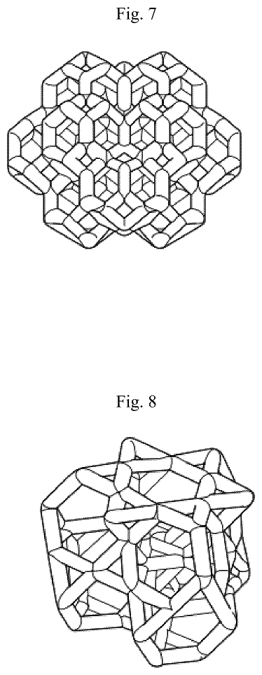

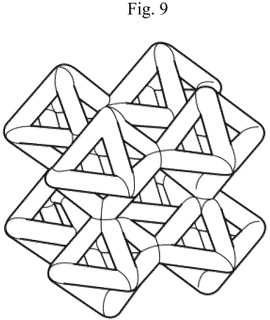

The wiping unit 14 may have a lattice-like structure, which is to say an architecture composed or one or more materials and empty areas. A higher or lower density of empty areas makes the wiping part 16 and/or the support element 18 stiffer or more flexible. This type of structure is in particular obtained by the additive manufacturing process. FIG. 6, FIG. 7, FIG. 8, and FIG. 9 show examples of the lattice. The lattice is a polyhedral-mesh structure, with polyhedrons connected to one another by some of their faces and/or edge corners. The lattice structure is elastically deformable. The lattice structure can be deformed by deformation of the polyhedrons. The lattice structure is a network of meshes that make it possible to change the shape of the device 10 while it is operating, and to regain its shape.

The wiping unit 14 may extend in a longitudinal direction and is capable of exerting a constant pressure on the optical surface 12 along the longitudinal direction. The pressure on the surface 12 is constant along the longitudinal shape of the wiping unit 14. The pressure on the surface 12 is constant along the longitudinal shape of the overhanging wiping unit 14. The pressure on the surface 12 is constant between the proximal end (close to the shaft 20) and the distal end of the wiping unit 14. The advantage is to ensure wiping of the same quality over the optical surface 12.

The constant pressure on the optical surface 12 may be exerted by portions which are stiffer than others within the wiping unit 14. More specifically, the wiping part 16 and/or the support element 18 comprises/comprise at least one first portion which is stiffer than at least one second portion in the longitudinal direction.

For example, it is possible to exert a constant pressure on the optical surface—and therefore possibly by modulating the stiffness within the wiping unit 14—with the wiping part 16 and/or the support element 18 at least partially comprising a lattice structure. The lattice then has a defined structure depending on the stiffness to be given to the more or less stiff portions. For this, the density of empty areas in the lattice is modulated. The advantage is that such a modulation of stiffness can be achieved easily. As an alternative or in combination, the wiping part 16 and/or the support element 18 comprise/comprises different materials. The materials are defined depending on the stiffness to be given to the more or less stiff portions. For example, the support element 18 comprises at least the portion formed by a first lattice structure configuration and/or by a first material, which configuration and/or material is configured to give the portion a first stiffness. For example, the wiping part 16 comprises at least the portion formed by a second lattice structure configuration and/or by a second material, which configuration and/or material is configured to give the portion a second stiffness. The first stiffness may be greater than the second stiffness—such that the support element 18 can additionally support and drive the wiping part 16. Again alternatively or in combination, the wiping part 16 and/or the support part 18 have/has a profile transverse to their longitudinal direction, of which the shape is variable in the longitudinal direction. The one or more profiles are defined on the basis of the pressure exerted by the wiping part on the optical surface 12.

This fine parametrization of its shape (overall, which is to say extending over all of the one-piece wiper, and locally, which is to say specifically at the specific parts and/or regions of said wiper) and the selection of the materials and processes for manufacturing it thus make it possible to obtain a one-piece wiper of which the shape and operation can be smoothly adapted to any specific application.

The use of manufacturing techniques as described in the present application also makes it possible to customize the shape of the wiper (notably its squeegee blade) to better adapt to a glazed surface which it is intended to wipe, notably in the case of especially curved or otherwise irregular surfaces which would be difficult to wipe or would not be fully wiped with the wipers known from the prior art.

In this regard, FIGS. 3 to 5 are sectional views through one example of the device according to FIGS. 1 or 2. More specifically, FIGS. 3 to 5 show various examples of profiles of the wiping part 16 and of the support element 18. The support element 18 supports the wiping part 16 in contact with the optical surface 12. The support element 18 supports the wiping part 16 facing the optical surface 12.

According to FIG. 3, the profile of the support element 18 supports the wiping part 16 away from the optical surface 12. The advantage is that it is easy to manufacture such a configuration. The profile of the wiping part 16 has an oval shape transversely to the longitudinal direction of the wiping unit 14. The major axis of the oval shape may be tangential to the direction of the wiping movement (or even parallel in the case of a linear movement). The wiping part 16 may comprise an extension 24 in the direction toward and in contact with the optical surface 12 to be wiped. The extension 24 is substantially in the center of the oval shape. The extension 24 is in line with the support element 18. The oval shape makes it possible to cause the extension 24 to exert pressure against the optical surface 12. The extension 24 is able to penetrate the oval shape by deformation of the oval shape. The profile of the wiping part 16 thus makes it possible to act as a spring urging the wiping unit 14 against the optical surface and to ensure high-quality wiping. In FIG. 3, the wiping part 16 may be in the form of a lattice, with such a structure also in the center of the oval shape—the same applies for the support element 18.

According to FIG. 4, the profile of the support element 18 laterally supports the wiping part 16 in a direction orthogonal to the optical surface 12. The advantage is that the bulk is reduced further. The profile and the structure of the wiping part 14 are the same as those in FIG. 3, with the same effects and advantages.

According to FIG. 5, the profile of the support element 18 also supports the wiping part 16 away from the optical surface 12. The advantage is that it is easy to manufacture such a configuration. The profile of the wiping part 16 comprises a succession of curves. In other words, the profile of the wiping part 16 has an S shape. The profile of the wiping part 16 ends in the extension 24 in the direction toward and in contact with the optical surface 12 to be wiped. The extension 24 is substantially in line with the support element 18. The curved shape makes it possible to cause the extension 24 to exert pressure against the optical surface 12. The curves act as hinges. The profile of the wiping part 16 thus makes it possible to act as a spring urging the wiping unit 14 against the optical surface 12 and to ensure high-quality wiping. In FIG. 5, the wiping part 16 may be in the form of a lattice—the same applies for the support element 18.

In FIGS. 3 to 5, the shape of the profile of the wiping unit 14 can vary, i.e. change, in the longitudinal direction of the wiping unit 14. This makes it possible to cause the wiping part 16 to exert a constant pressure on the optical surface 12, by taking into account the deformation of the wiping unit 14. The changing profile also makes it possible to take into account the tangential speed of the wiping unit 14 (in particular of the wiping part 16) which is different between the distal and proximal ends of the wiping unit 14—in particular in the case of the circular movement in FIG. 1. By way of example, the profile of the support element 18 in FIGS. 3 and 5 may have a varying thickness so as to vary its stiffness and the spring effect against the optical surface 12; that of FIG. 4 may vary, for the same effects. The profile of the wiping part 16 in FIGS. 3 and 4 may comprise a part in the form of a lattice of varying density so as to vary the spring effect against the optical surface 12; that of FIG. 5 may have a varying thickness for the same effects.

As indicated above, the wiping unit 14 has a back-and-forth wiping movement—which is linear and/or circular. The wiping unit 14 moves between the first end position and the second end position. The dimension of the wiping unit 14 in a direction orthogonal to the optical surface 12 is different between the end positions in relation to the dimension at the end positions. The wiping part 16 and/or the support element 18 is/are capable of absorbing the variation in dimension. In other words, the vertical takeup (or the bulk) in a direction orthogonal to the optical surface 12 of the wiping unit 14 upon changes in direction is compensated for by the wiping part 16 and/or the support element 18. The wiping unit 14 works like a spring in a direction orthogonal to the optical surface (or transversely to the optical surface 12). This makes it possible to avoid the vertical takeup at the end positions. This makes it possible to avoid movements in a direction orthogonal (or transversely) to the optical surface 12 and notably jumps in a direction orthogonal (or transversely) to the optical surface 12, which adversely affect the wiping quality. This also avoids noise. This also makes it possible to do away with a pivot connection between the wiping unit 14 and the driveshaft 20. As a result, the number of parts is reduced, as is the manufacturing cost. The compactness of the device is also improved.

More specifically, between the two end positions, the drive of the wiping part 16 is such that the wiping part 16 is inclined in contact with the optical surface 12. In FIGS. 3 to 5, for example, the extension 24 is inclined during the wiping. When there is a change in direction at the end positions, the inclination of the wiping part 16 changes direction. The extension 24 then makes this change via the configuration shown in FIGS. 3 to 5. As a result, the wiping part 16 (and therefore the wiping unit 14) has a dimension (or a bulk), in a direction orthogonal to the optical surface 12, which is reduced when the wiping unit is moving between the end positions owing to the inclination. At the end positions, the wiping part (and therefore the wiping unit 14) has a dimension (or a bulk), in a direction orthogonal to the optical surface 12, which is larger owing to the turning around of the extension 24 (or change in direction).

To compensate for (or absorb) the variation in dimension (or bulk), the wiping unit 14—and more specifically, the wiping part 16 and/or the support element 18—acts like a spring. For this, for example, the wiping part 16 and/or the support element 18 may be at least partially in the form of a lattice, the lattice absorbing the variation in dimension. As an alternative or in combination, the profile of the wiping part 16 and/or of the support element 18, in a direction orthogonal to the optical surface 12, absorb(s) the variation in dimension. In FIGS. 3 and 4, the extension 24 is capable of penetrating the oval shape by deformation of the oval shape, as it turns around. In FIG. 5, the extension 24 causes the curves to be compressed as it turns around. The greater stiffness of the support element 18 makes it possible to keep the wiping unit 14 in contact with the optical surface 12. As a result, the profile of the wiping part 16 and/or the support element 18 may be dimensioned to turn around “conventionally”.

The device 10 may also comprise a duct for cleaning liquid in the wiping unit 14. This also makes it possible to spray the liquid as close as possible to where the wiping unit 14 makes contact with the optical surface 12. This makes it possible to improve the wiping of the optical surface 12. For example, the duct for cleaning liquid is a channel for liquid (not shown in the figures) fitted or formed in the lattice-like wiping unit 14—or in an area of the lattice in the form of a channel. Orifices for spraying the liquid are also directly integrated in the wiping unit 14. This makes it possible to benefit from the architecture of the wiping unit 14 to make it possible to carry fluid.

According to FIG. 2, the device 10 comprises a duct 30 connected to the wiping unit 14. The duct 30 makes it possible to carry the cleaning fluid toward the wiping unit 14. This is also the case for FIG. 1.

The device 10 may also comprise resistive heating tracks in the wiping part. This makes it possible to heat the wiping part 16 in order to keep it properly flexible when it is cold, or to melt ice or snow which might prevent it from working correctly. For this, a conductive material is inserted in the wiping unit 14. This is done during the step of manufacturing the wiping unit 14, for example by additively manufacturing such a material in the wiping unit 14.

The manufacturing processes mentioned above make it possible to obtain configurations such as those given by way of example in these figures.

The present invention has been described in relation to specific embodiments, which have purely illustrative value and should not be considered limiting. In general, it will be obvious to a person skilled in the art that the present invention is not limited to the examples illustrated and/or described above.

What is claimed is:

1. A device for wiping an optical surface of at least one optical element of a vehicle, comprising:
a wiping unit having a wiping part for wiping the optical surface and a support element for supporting the wiping part, the wiping part moving in a wiping movement to wipe the optical surface by making contact with the optical surface,
a drive member for driving the wiping unit,
the wiping unit being in one piece.

2. The device as claimed in claim 1, wherein a material forming the wiping part is different from a material forming the support element.

3. The device as claimed in claim 1, wherein the support element includes at least one portion which is stiffer than at least one portion of the wiping part.

4. The device as claimed in claim 1, wherein the wiping unit extends in a longitudinal direction and is capable of exerting a constant pressure on the optical surface along the longitudinal direction.

5. The device as claimed in claim 4, wherein the wiping part and/or the support element include(s) at least one first portion which is stiffer than at least one second portion in the longitudinal direction.

6. The device as claimed in claim 4, wherein the wiping part and/or the support element at least partially include(s) a lattice structure.

7. The device as claimed in claim 1, wherein the wiping unit has a wiping movement which goes back and forth between end positions while the optical surface is being wiped, the dimension of the wiping unit in a direction orthogonal to the optical surface being different between the end positions in relation to the dimension at the end positions, the wiping part and/or the support element being capable of absorbing the variation in dimension.

8. The device as claimed in claim 1, including a duct for cleaning liquid in the wiping unit.

9. The device as claimed in claim 1, wherein the wiping unit is obtained as a single piece by a manufacturing process.

10. The device as claimed in claim 1, wherein the wiping unit is obtained by an additive manufacturing process.
